(19) United States
(12) Patent Application Publication
(10) Pub. No.: US 2024/0007763 A1
(43) Pub. Date: Jan. 4, 2024

(54) IMAGING SYSTEM WITH EMI CORRECTION

(71) Applicant: Varex Imaging Corporation, Salt Lake City, UT (US)

(72) Inventors: Arezou Edalati, Salt Lake City, UT (US); Paul Pryor, West Jordan, UT (US); Pieter Gerhard Roos, Sandy, UT (US)

(73) Assignee: Varex Imaging Corporation, Salt Lake City, UT (US)

(21) Appl. No.: 18/194,576

(22) Filed: Mar. 31, 2023

Related U.S. Application Data
(60) Provisional application No. 63/357,603, filed on Jun. 30, 2022.

(51) Int. Cl. H04N 25/617; H04N 25/30

(52) U.S. Cl. CPC H04N 25/617; H04N 25/30

(57) ABSTRACT

A detector, comprising: a plurality of first pixels, each first pixel configured to convert radiation into an electrical signal; a plurality of second pixels; and a plurality of data lines coupled to the first pixels and the second pixels; control logic configured to combine a signal from at least one of the second pixels with an electrical signal from one of the first pixels; wherein electrical connections of each of the second pixels are different from electrical connections of the first pixels such that for each second pixel: components of the second pixel are different from components of each of the first pixels; electrical connections between components of the components of the second pixel are different from electrical connections between the components of each of the first pixels; or a number of electrical connections to the second pixel are different from a number of electrical connections to each of the first pixels.

X-ray detectors may suffer from electromagnetic interference (EMI). EMI may add noise that varies in time and space during a frame. EMI may be mitigated with additional shielding to reduce the EMI.

### BRIEF DESCRIPTION OF SEVERAL VIEWS OF THE DRAWINGS

FIG. 1 is a block diagram of a detector according to some embodiments.

FIGS. 2A-2D are block diagrams of pixels of detectors according to some embodiments.

FIGS. 3A-3G are block diagrams of connections of pixels and data lines of a detector according to some other embodiments.

FIG. 4 is a block diagram of a detector including a detector according to some embodiments.

FIG. 5 is a flowchart of techniques of operating a detector according to some embodiments.

FIG. 6 is a flowchart of techniques of operating an imaging system according to some embodiments.

FIG. 7 is a block diagram of a 2D x-ray imaging system according to some embodiments.

### DETAILED DESCRIPTION

Some embodiments relate to imaging systems with electromagnetic interference (EMI) correction. As will be described in further detail below, various configurations of data lines and/or pixels may be used to generate signals that may be used to reduce or eliminate noise due to EMI.

X-ray flat panel detectors (FPDs) may suffer from low frequency magnetic field electromagnetic interference. When an FPD is in vicinity of magnetic field noise from sources such as transformers, solenoids, switches, motors, or the like, image artifacts may appear in the x-ray images. Such artifacts may make fine details in x-ray images invisible or harder to detect. As a result, a medical diagnosis based on the image may be affected.

Some industry trends may exacerbate the effects of EMI. For example, copper-painted plastic housing may reduce cost and weight; however, the susceptibility to EMI may be increased. Conductive shielding materials may be used to protect against high frequency EMI; however, for low frequency EMI, a relatively thick sheet of conductive material may be needed to effectively reduce the low frequency EMI. This additional material may increase the weight of the FPD, potentially beyond a specified limit, and attenuate x-ray radiation intended to be detected. High permeability magnetic shielding materials may reduce EMI but may also degrade the image quality due to attenuating the x-ray radiation. Embodiments described herein may allow for detectors with less expensive housing components and/or fewer shielding materials and still maintain the same or an increased performance.

Software corrections of EMI may be difficult as the noise may vary both in time and space. The noise may change frame to frame, the magnitude may change based on location, or the like. Correlated double sampling may not alleviate the interference as the magnitude may change faster than a readout time of a row. As a result, a second sampling of a row may include a different, uncorrelated contribution of EMI that is not eliminated by correlated double sampling.

To alleviate the effect of EMI, in some embodiments, EMI noise may be sampled. The sampling of the EMI noise may be done both locally and within the same frame that it occurred. As will be described in further detail below, sense lines may be used to sample the EMI generated noise when sampling a signal using data lines. Subsequently, the sampled noise may be subtracted from the sampled signal. In addition, as the sampled noise that may be removed from sampled signals, the operation may be performed within a single frame. As a result, the detectors described herein may be used in both radiographic and fluoroscopic applications.

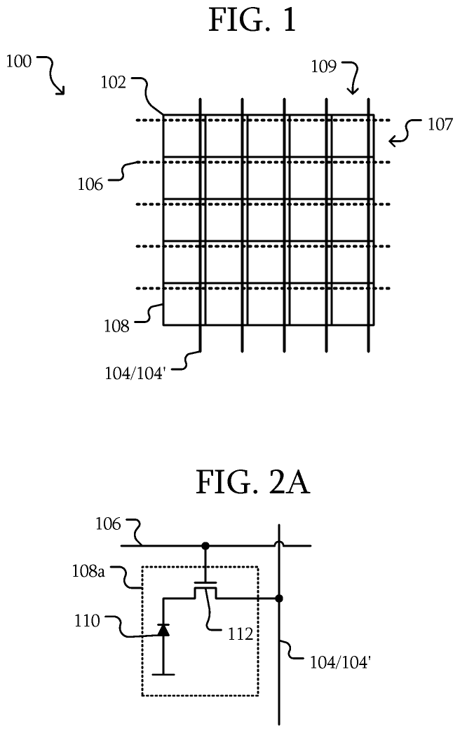

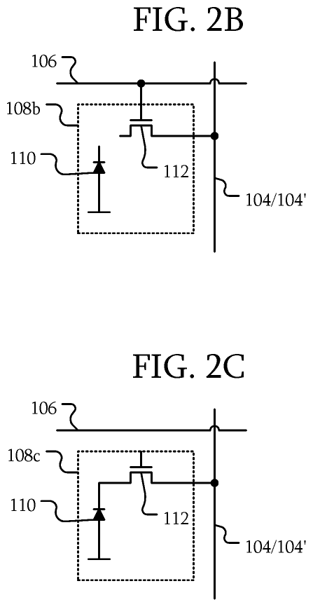

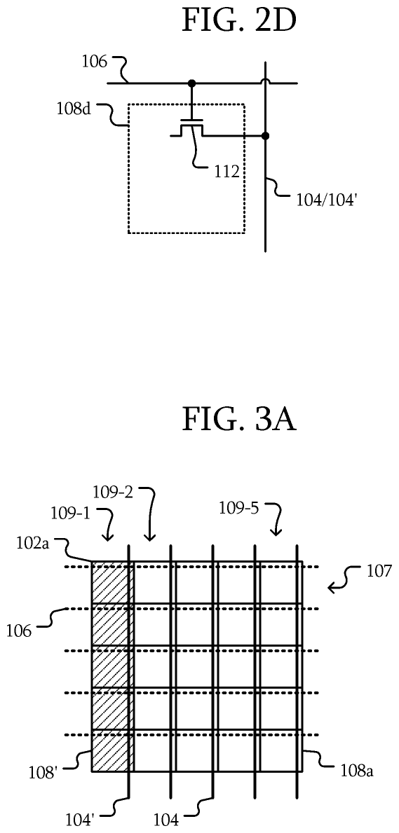

FIG. 1 is a block diagram of a detector according to some embodiments. FIGS. 2A-2D are block diagrams of pixels of detectors according to some embodiments. Referring to FIGS. 1-2D, in some embodiments, a detector 100 includes an array 102. The array 102 may include a variety of pixels 108. The pixels 108 are disposed in rows 107 and columns 109.

The detector 100 includes multiple gate lines 106 associated with rows 107 of pixels 108 and multiple data lines 104 associated with columns 109. As will be described in further detail below, the data lines 104 may be configured to provide signals to sampling circuits (not illustrated). These signals may include a desired signal from detected x-rays and a signal due to EMI. In some embodiments, a data line 104 may be dedicated to sense EMI and may be referred to as a data line 104′. In some embodiments, a data line 104 may be configured to provide the desired signal for some rows 107 and configured to provide an EMI signal for other rows 107. When providing the EMI signal, the data line 104 may be referred to as a data line 104′. In some embodiments, when sampling different rows 107, data lines 104 that are operated as data lines (or sense lines) 104′ to sense an EMI signal may change from row 107 to row 107. Data lines 104 that may change from providing a desired signal to providing an EMI signal are illustrated as data lines 104/104′.

Pixel 108a is an example of a pixel 108 that is configured to generate a desired signal based on incident radiation, such as x-rays. The pixel 108a includes the sensor 110 electrically connected to a switch 112. The sensor 110 may include devices such as a photodiode, photodetector, a circuit including such devices, or the like. The sensor 110 is configured to convert x-rays, light, or other photons into an electrical signal, such as a charge or voltage. A scintillator, direct conversion material, or other x-ray conversion material may be part of the array 102 and configured to convert incident x-rays into photons that the sensor 110 may convert into an electrical signal. For example, a scintillator may include a variety of materials configured to convert x-ray photons into photons detectable by the sensors 110 such as cesium iodide (CsI), cadmium tungstate (CdWO₄), polyvinyl toluene (PVT), gadolinium oxysulfide (Gd₂O₂S; GOS; Gadox), gadolinium oxysulfide doped with terbium (Gd₂O₂S:Tb), or the like. Examples of direct conversion materials include cadmium telluride (CdTe), cadmium zinc telluride (CdZnTe or CZT), mercury iodide (HgI), lead iodide (PbI), selenium, or the like.

The switch 112 may be a variety of devices including transistors such as transistors based on amorphous silicon (a-Si), complementary metal oxide semiconductors (CMOS), indium gallium zinc oxide (IGZO), or the like. The switch 112 is electrically connected to a corresponding gate line 106 and a corresponding data line 104. The pixel 108a may include additional connections, such as bias lines. A bias line (not illustrated) may connect to sensor 110 in a column 109 of pixels 108a. The pixel 108a may include other components and electrical connections. A signal may be integrated and/or collected in the pixel 108a. That signal may be read out through the switch 112 and a corresponding data line 104 in response to a signal on the corresponding gate line 106. For example, a charge may be integrated on the sensor 110. That charge may be read out through the switch and the data line 104.

As will be described in further detail below, in some embodiments, the array 102 may include second pixels 108′. Pixels 108b-d are examples of second pixels 108′. Pixels 108b-d may be similar to pixel 108a; however, the electrical connections associated with pixels 108b-d may be different from that of pixel 108a. Other parasitic connections between the switch 112, the data line 104, the gate line 106, the sensor 110, or the like may still exist; however, the connections of, within, or to the pixels 108b-d are different such that a contribution of an otherwise desired signal generated due to incident x-rays from the sensor 110 is reduced or eliminated in a signal on the data line 104.

For example, in pixel 108b, the sensor 110 is electrically disconnected from the switch 112. However, the loading of the switch 112 on the data line 104′ may be similar to that of pixel 108a on a data line 104 (with the switch in an off state or the pixel sensor 110 with no or minimal signal). In addition, parasitic connections between the switch 112 and the sensor 110, the connection from the switch 112 to the data line 104′, or the like may also be similar to the pixel 108a. Accordingly, the load on the data line 104′ may be similar; however, the signal due to a signal acquired by the sensor 110 may be reduced or eliminated. A signal may accumulate on the sensor 110 due to incident x-rays. The switch 112 may be activated similar to switches in pixels 108a when those pixels 108a are sampled. However, the switch 112 of pixel 108b is not connected to the sensor 110. As a result, the signal on the sensor 110 either does not appear on the data line 104′ or only appears in a significantly reduced form due to parasitic connections.

In another example, for pixel 108c, the switch 112 is not electrically connected to the gate line 106. The switch 112 may be configured to be in an off state. Accordingly, even if a signal accumulates on the sensor 110 and could be transmitted through the switch 112, the switch 112 is not connected to be activated. Thus, that accumulated signal again does not appear or only appears in a significantly reduced form due to parasitic connections.

In another example, for pixel 108d, the sensor 110 may not be present. The pixel 108d may otherwise be the same as pixel 108a. The lack of a sensor 110 may be implemented by not forming all of the structures of the sensor 110, not forming some of the structures, such as one or both electrodes or the active material, or the like. Thus, the sensor 110 may be wholly or partially not present. The loading of the switch 112 on the data line 104′ may be similar to that of pixel 108b on a data line 104.

Although pixels 108b-108d are used as examples, other embodiments may include pixels 108′ with other electrical connections different from the first pixels 108a that are themselves different from pixels 108b-108d. Any difference that prevents or significantly reduces the contribution of an otherwise desired signal in an output of a pixel 108′ on data line 104′ may be a difference in the electrical connections relative to a first pixel 108a.

In operation, magnetic field or other EMI noise may exist in vicinity of the detector 100. The noise is created on data lines 104 and will be added to the desired signal which read out when the switch 112 is on. A charge amplifier will amplify the desired signal as well as the noise, which may appear in the image as artifacts.

Data lines 104′ coupled with pixels 108′ such as pixels 108b-d, may have substantially the same susceptibility to EMI as data line 104 coupled with pixels 108 such as pixels 108a. As a result, substantially the same EMI noise will be generated on both data lines 104′ and data lines 104. By reading the data line 104′ signal and subtracting it from data line 104 signal, which includes both the desired signal and the EMI noise, the EMI noise may be reduced or eliminated, leaving the desired signal.

In some embodiments, the data lines 104′ and the data lines 104 have the same or substantially the same susceptibility to a magnetic field or other EMI. The data lines 104′ and the data lines 104 have the same or substantially the same impedance, parasitic interactions with other components, or the like. As a result, EMI noise appears on the data line 104′ may appear without the need of the sensor 110 being attached to the data line 104′.

As described above, in some embodiments, the electrical connections of each pixel 108′ that are different from the pixels 108 include electrical connections between components of the pixel 108′. In other embodiments, the electrical connections of each pixel 108′ that are different from the pixels 108 may include electrical connections to the pixel 108′ such as in pixel 108c.

In some embodiments, each row 107 of the array 102 includes at least one of the pixels 108a and at least one of pixels 108′ that has electrical connections different than the pixel 108a. As will be described in further detail below, multiple pixels 108′ may be included in each row 107. Each of these pixels 108′ in conjunction with the corresponding data line 104′ may be configured to generate an EMI noise signal at substantially the same time that a desired signal combined with the same or similar EMI noise signal is generated on the data line 104 from a corresponding pixel 108a.

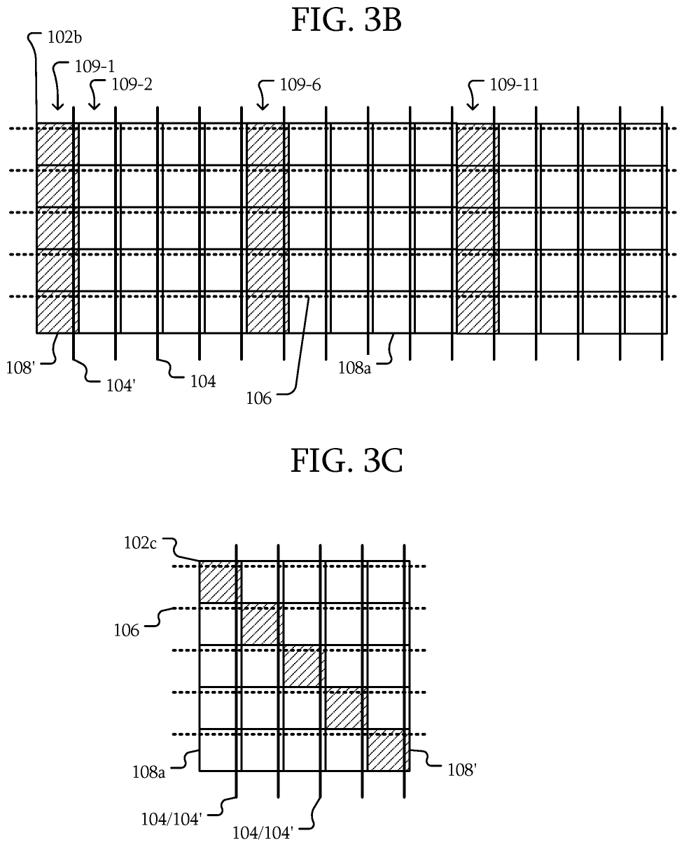

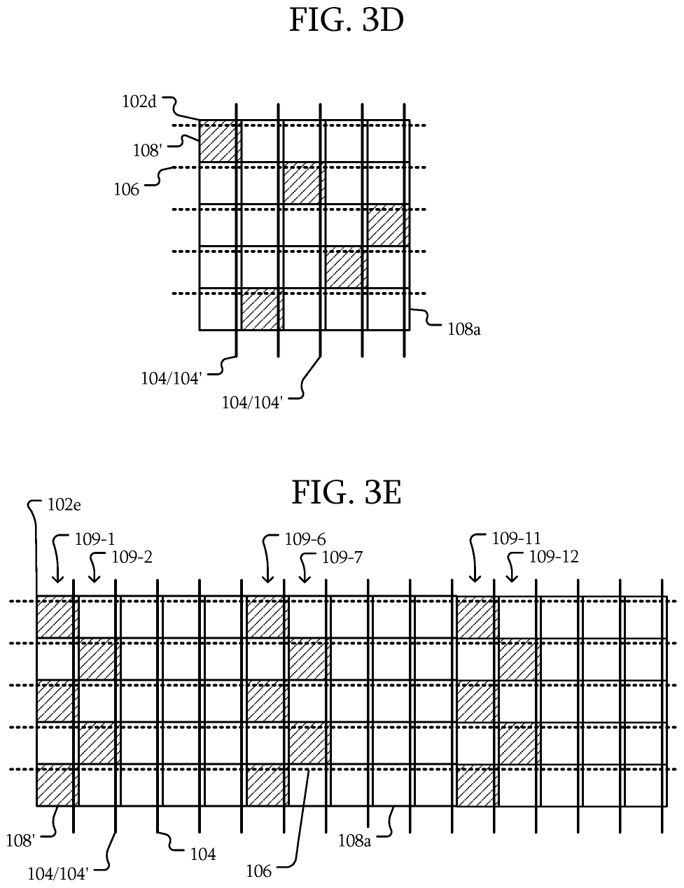

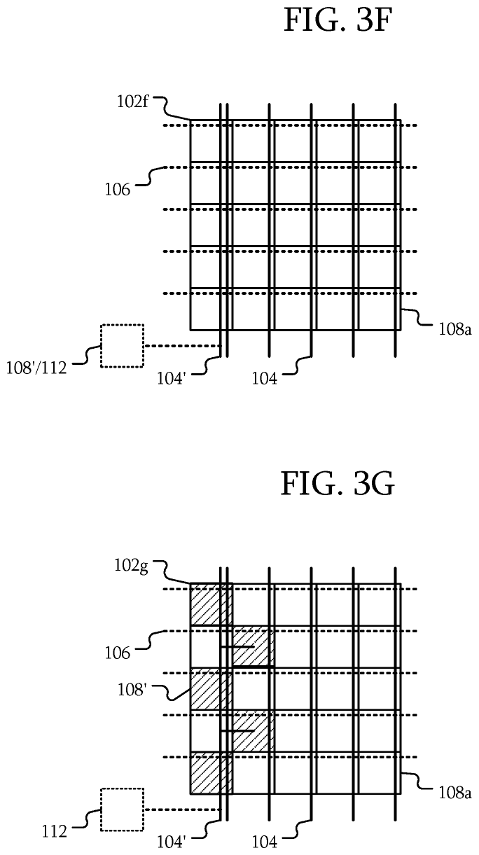

FIGS. 3A-3G are block diagrams of connections of pixels and data lines of a detector according to some other embodiments. Referring to FIG. 3A, in some embodiments, at least one group of the pixels 108′ form one of the columns 109-1 (or sense column) of the array 102a. Other columns 109 such as columns 109-2 to 109-5 include pixels 108a. In the array 102a and the other examples described herein, a pixel 108′ may be illustrated with shading while a pixel 108a are not. While a certain number of rows 107 and columns 109 are used as an example, in other embodiments, the number of either or both may be different.

Referring to FIG. 3B, in some embodiments, the array 102b may be similar to the array 102a. However, the array 102b may include multiple groups of pixels 108′. Each group of the pixels 108′ may be disposed in a different column 109. Thus, the array 102b may include multiple columns 109 including second pixels 108′. In this example, the columns 109-1, 109-6, and 109-11, which include second pixels 108′, are examples of the multiple columns. A column 109 with pixels 108′ may repeat every 5 columns. Although three columns 109 with second pixels 108′ are used as an example, in other embodiments, the number may be any integer greater that one.

In addition, although the pitch or spacing of the columns 109 with second pixels 108′ is 5 pixels, in other embodiments, the pitch may be different. For example, the pitch may be any integer greater than one. Furthermore, the pitch between any two adjacent columns 109 with second pixels 108′ may be different than the pitch between another two adjacent columns 109 with second pixels 108′. However, as in this embodiment, the pitch may be the same.

In some embodiments, some columns 109 include only pixels 108′. However, in other embodiments, each column 109 of the array 102 includes at least one pixel 108a. That is, each column 109 may include some pixels 108′ but no column 109 includes all pixels 108′.

In some embodiments, columns 109 formed by some to all pixels 108′, may introduce a regular artifact into a resulting image. That is, the pixels 108′ may not contribute a desired signal to the image and may only be used to reduce or eliminate EMI. Accordingly, as will be described in further detail below, other configurations of pixels 108′ among an array 102 may be used.

Referring to FIG. 3C, in some embodiments, the array 102c may be similar to the arrays 102a-b. However, each second pixel 108′ of a row 107 of the array 102c is offset from at least one second pixel 108′ in another row 107 of the array 102c. In this example, a second pixel 108′ in one row 107 is offset from a second pixels 108′ in an adjacent row by one pixel in a diagonal pattern. In other embodiments, the second pixels 108′ in adjacent rows may be offset by a different number of pixels. As a result, the array 102c may have the pixels 108′ distributed across the array 102c. The array 102c may lack an appearance of one or more defective columns.

In some embodiments, if the separation between pixels 108′ of adjacent rows 107 is greater than one, additional pixels 108a with signals including desired signals from the conversion of incident radiation may be adjacent to each of the pixels 108′. In particular, each of the eight pixels 108 that surround a pixel 108′ may be pixels 108a. A desired signal from those pixels 108a may be used to interpolate a value to replace the missing signal associated with the pixel 108′. While the use of the eight surrounding pixels 108 has been used as an example of pixels from which signals may be used to interpolate a value, in other embodiments, signals from less than all eight, including only one pixel 108, and/or signals from pixels 108 beyond the immediately adjacent pixels 108 may be used to interpolate the value.

Referring to FIG. 3D, in some embodiments, the array 102d may be similar to the array 102c of FIG. 3C. However, the pixels 108′ of adjacent rows 107 may be offset by differing number of pixels 108. For example, a pixel 108′ of a particular row 107 may be offset from a pixel 108′ of an adjacent row 107 by any positive or negative number of pixels 108, such as +/−1, +/−2, +/−3, or more pixels 108. A pixel 108′ of another row 107 may be offset by a different amount.

In some embodiments, the second pixels 108′ may be offset from each other in the array 102d such that the second pixels 108′ are randomly distributed or distributed in a non-symmetrical local pattern (within a specified p×q area or subset of the array 102d, where p represents number of rows 107 and q represents number of columns 109). In some embodiments, the second pixels 108′ may be distributed such that the second pixels 108′ are randomly distributed (or non-symmetrically distributed) but have a substantially uniform density. As used here, a substantially uniform density means a number of second pixels 108′ in a given area of pixels 108 is within a defined range, such as from about 2 to about 10 or more across the array 102d. For example, the second pixels 108′ may be distributed across the array 102d such that for any n×n area of pixels 108 (where n is the number of rows 107 and the number of columns 109), m pixels are second pixels 108′, such as 1, 2, 3, or more. In another example, for any n×n area of pixels 108, a number of second pixels 108′ that are present may be within a range, such as from about 2 to about 10 or more. That is, even though the density in the n×n area may change, it may vary within a range such that enough EMI signal may be obtained while the loss of desired signal due to the use of pixels 108′ may be limited.

Referring to FIG. 3E, in some embodiments, the second pixels 108′ may be distributed across the array 102e similar to the array 102b. However, the second pixels 108′ may be disposed within a series of columns 109, such as 2 or more but less than the pitch to an adjacent group of columns 109 containing second pixels 108′. Here, two columns 109-1 and 109-2 are examples of a series of columns. The series may be repeated in columns 109-6 and 109-7 and columns 109-11 and 109-12.

In some embodiments, the second pixels 108′ may be distributed such that every row 107 of an array 102 includes at least one of the pixels 108′. That is, regardless of whether the distribution of the pixels 108′ is similar to that of array 102a-e or in another similar distribution, every row 107 includes at least one pixel 108′.

In some embodiments, every row 107 may include multiple second pixels 108′. Within a row 107, the pixels 108′ may be located such that the distance from a pixel 108a to a pixels 108′ is less than a number of pixels, such as 5, 10, 20, or more. In some embodiments, even if the pixels 108′ are distributed across the array 102 in a random manner, within any given row 107, the second pixels may be uniformly spaced. For example, even if the pixels 108′ are offset as in array 102d of FIG. 3D, within a given row 107, the pitch of the pixels 108′ may be the same across the row 107. In some embodiments, the pitch of pixels 108′ in other rows may be the same; however, the locations of the pixels 108′ may be relatively shifted along the row 107 from column 109 to column 109.

In some embodiments where dedicated second pixels 108′ are present, a signal may be generated to approximate a desired signal that would have been generated by a second pixels 108′ if it was configured as a first pixel 108. As described above, any technique may be used to combine signals from adjacent pixels, pixels within a threshold distance, or the like to generate the approximated desired signal.

Referring to FIG. 3F, in some embodiments, the array 102f may include one or more additional data lines 104′. The additional data lines 104′ may be disposed in parallel with and along a corresponding one of the data lines 104. The additional data lines 104′ may be disposed in columns of any column 109 of pixels 108′ in arrays 102a, 102b, or the like. That is, instead of using pixels 108′ in a column in arrays 102a, 102b, or the like, an additional data line 104′ may be used.

In some embodiments, the additional data lines 104′ are disposed on a different layer of metal of the array 102f from the data lines 104. The additional data lines 104′ may be disposed over the corresponding data lines 104. As a result, the additional data lines 104′ may be hidden from a user. In some embodiments, the additional data lines 104′ are disposed on the same metal layer as the data lines 104. The additional data lines 104′ may be disposed adjacent to the corresponding data lines 104.

In some embodiments, the additional data lines 104′ may have substantially the same structure as the corresponding data lines 104. In other embodiments, the structure of the additional data lines 104′ may be different in a manner results in the susceptibility of the additional data lines 104′ to EMI to be closer to or substantially the same as a data line 104. For example, the additional data lines 104′ may have a different width, thickness, or the like. In some embodiments, a switch 112, a second pixel 108′ including the switch 112, another structure with a similar capacitance, or the like or may be coupled to the additional data lines 104′ to simulate the loading of the switches 112 of the pixels 108a that are coupled to the data lines 104. The second pixel 108′/switch 112 is illustrated as an example of such structures. In some embodiments, a number of pixels 108′ that are coupled to the additional data lines 104′ may be less than that of an associated data line 104. The number of second pixels 108′ that are coupled to the additional data line 104′ may be a number that is sufficient to have the additional data line 104′ approximate the susceptibility of the data lines 104 to EMI. In some embodiments, that number may be one second pixel 108′. In other embodiments, the additional data line 104′ is not coupled to any pixels 108′.

In some embodiments, the presence of the additional data line 104′ may result in a lower sensitivity of the pixels 108a of a column 109 relative to a neighboring column 109. Accordingly, values sampled from a column 109 that overlaps with an additional data line 104′ may be adjusted to compensate for the reduced sensitivity. In some embodiments, the location of the additional data line 104′ may be on another metal layer and overlap the associated data line 104. As a result, a reduction in sensitivity of the pixels 108a of the column 109 may be reduced or eliminated as the sensitivity was already reduced due to the presence of the data line 104.

In some embodiments, the fill factor of the array 102f may not be affected by the additional data line 104′. That is, in contrast to embodiments where a pixel 108a is replaced with a pixel 108′ and thus, does not contribute a desired signal to a resulting frame, the use of the additional data line 104′ does not have missing pixels 108a that convert radiation into electrical signals.

Referring to FIG. 3G, in some embodiments, the array 102g may be similar to the array 102f. However, the data line 104′ may be coupled to some second pixels 108′. The second pixels 108′ do not share a data line 104 with other pixels 108. Rather, the second pixels 108′ are coupled to the dedicated additional data line (or sense line) 104′. While a distribution of second pixels 108′ has been illustrated as being similar to that of array 102e illustrated in FIG. 3E, in other embodiments, the distribution of second pixels 108′ may be similar to other configurations described above.

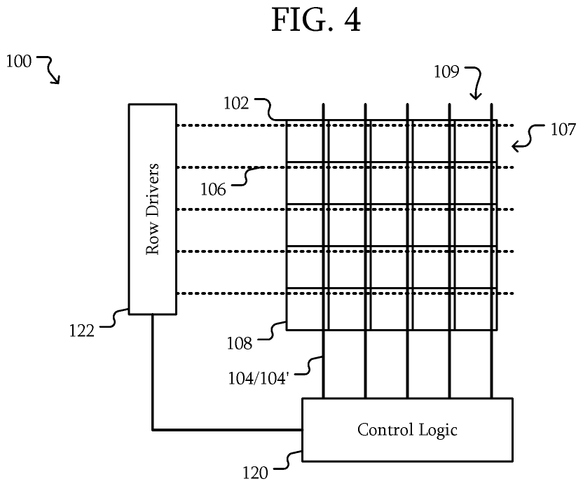

FIG. 4 is a block diagram of a detector including a detector according to some embodiments. The imaging system 100 includes an array 102. The array 102 may be any of the arrays 102 described above, such as arrays 102a-f or the like. The array 102 includes data lines 104/104′. As described above, in some embodiments, data lines 104′ may be dedicated data lines 104′ that are coupled to second pixels 108′ for every row 107 or additional data lines 104′ coincident with another data line 104 of a column 109. In other embodiments, the operation of a data line 104/104′ may change based on whether the data line 104/104′ is coupled to a pixel 108a or a pixel 108′ for a given row 107.

The imaging system 100 includes row drivers 122. The row drivers 122 may be configured to generate signals on gate lines 106 to selectively activate rows 107 of the array 102.

The imaging system 100 includes control logic 120. The control logic 120 includes sampling circuits configured to sample signals from the pixels 108. The sampling circuits include circuits such as charge amplifiers, analog-to-digital converters (ADCs), sample-and-hold circuits, or the like configured to perform the sampling. The sampling circuits are coupled to the pixels 108 through data lines 104/104′. The control logic 120 may include a general purpose processor, a digital signal processor (DSP), an application specific integrated circuit (ASIC), a microcontroller, a programmable logic device, discrete circuits, a combination of such devices, or the like. The control logic 120 may include other circuits to couple the control logic 120 to the row driver 122, or the like to enable the control logic 120 to control the operation of such circuits.

The control logic 120 may be configured to control various operations described herein. As will be described in further detail below, the control logic 120 may be configured to adjust electrical signals from the pixels 108a of the array 102 based on electrical signals received through at least one of the at least one data line 104′. In some embodiments, the control logic 120 is configured to combine a signal from a pixel 108a with a signal from a single pixel 108′ or through a single data line 104′. However, in other embodiments, a signal from a pixel 108a may be combined with a signal generated based on multiple pixels 108′ or signals received through multiple data lines 104′.

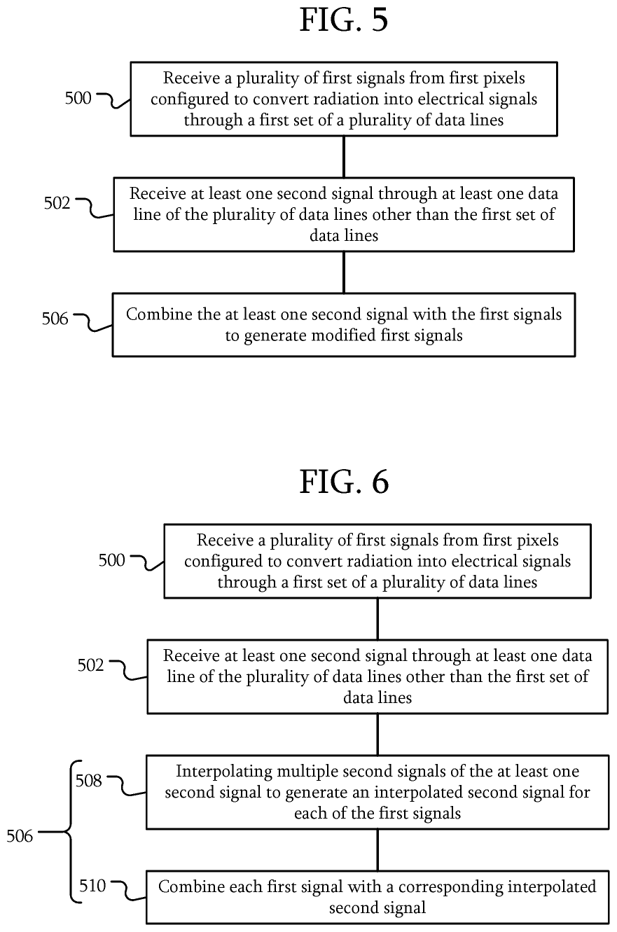

FIG. 5 is a flowchart of techniques of operating a detector according to some embodiments. Referring to FIGS. 1-5, various operations of the detector 100 will be described. In 500, multiple first signals are received from pixels 108a configured to convert incident radiation into electrical signals through a first set of data lines 104. For example, the control logic 120 may be configured to control the row driver 122 to activate a row 107 of the array 102. An electrical signal, such as a current or voltage, may be sampled by the control logic 120 through data lines 104.

In 502, at least one second signal is received through at least one data line 104′ of a second set the of data lines 104/104′ other than the first set of data lines 104. The at least one second signal has a reduced contribution due to radiation conversion relative to at least one first signal from a neighboring data line 104 of the first set of the plurality of data lines 104. The data lines 104′ of the second set may be the same for each row 107, may be different for each row 107, or may be shared by some rows 107 and different for others, or the like. The data lines 104′ of the second set may be different according to the various embodiments described above. For example, in some embodiments, the at least one second signal is received through a data line 104′ not coupled to any pixels such as described with respect to FIG. 3F. In other embodiments, the at least one second signal is received through a data line coupled to a second pixel 108′ with electrical connections that are different from electrical connections of the first pixels 108 such that for the second pixel, components of the second pixel are different from components of each of the first pixels such as that described with respect to FIG. 2D, electrical connections between components of the components of the second pixel 108′ are different from electrical connections between the components of each of the first pixels such as that described with respect to FIG. 2B, or a number of electrical connections to the second pixel 108′ are different from a number of electrical connections to each of the first pixels 108 such as that described with respect to FIG. 2C.

In some embodiments, the electrical connections of each of the second pixels 108′ are different from electrical connections of the first pixels. The at least one data line 104′ may include one or more data lines 104′ that are coupled to corresponding second pixels 108′ when the gate line of a particular row 107 is activated. In another embodiment, the second data line 104′ may include a dedicated data line 104′ as described with respect to array 102f. The control logic 120 may be configured to sample the signal received through the data line 104′.

As a result, the first and second signals are available. The first signals include both a portion representing a desired signal and a portion representing EMI. The second signals include a portion representing the EMI.

In 506, the at least one second signal is combined with the first signals to generate modified first signals. The combination may be performed in a variety of ways. In some embodiments, the second signal of a row may be subtracted from each of the first signals of the row. In another embodiment, the leftmost second signal, the rightmost second signal, or the nearest second signal may be subtracted from the a given first signal. As the first and second signals were sampled substantially simultaneously for a given row 107, the EMI contribution to the second signal should be similar to the EMI contribution to a first signal. In particular, this correlates the EMI in time with the desired signal. Substantially simultaneously means within a readout cycle for a given row 107.

FIG. 6 is a flowchart of techniques of operating an imaging system according to some embodiments. Referring to FIGS. 1-4 and 6, in some embodiments, the operation may be similar to the corresponding operations 500, 502, and 506 of FIG. 5. However, the combination of the first and second signals in 506 may include interpolating multiple second signals of the at least one second signal to generate an interpolated second signal for each of the first signals in 508 and combining each first signal with a corresponding interpolated second signal in 510. As a result, the second signal may be correlated to a given pixel 108a in space as well as time.

The interpolation in 506 may be performed in a variety of ways. In some embodiments, the two second signals may be averaged to generate an interpolated second signal that may be subtracted from the first signal. In some embodiments, the two closest second signals and the position of a pixel 108a that generated a first signal relative to the two second pixels 108′ may be used to combine the signals using a weighted average. Equation 1 is an example where FSₙ is an n-th first signal from a pixel 108a at column 109-n received through a data line 104. SSⱼ and SSₖ are j-th and k-th second signals received from data lines 104′ at columns 109-j and 109-k where j<n<k. The result is an n-th modified signal MSₙ.

$$\\ \begin{matrix}{MS}_{n} = {FS}_{n} - ( {SS}_{j} + ( {SS}_{k} - {SS}_{j} ) \cdot \frac{n - j}{k - j} ) & ( 1 )\end{matrix}$$

In another embodiment, multiple second signals may be combined together to generate a spline interpolation function. For example, a set of pairs of a pixel column and second signal from data lines 104′ for a row may be used to generate a spline interpolation function. The column associated with a given data line 104 may be used to generate an EMI signal for that particular pixel based on the column and the spline interpolation function.

Although interpolation between nearest neighbors and a spline interpolation technique have been used as examples, any interpolation technique may be used to determine an interpolated second value to subtract from a first signal to generate a modified first signal.

In some embodiments, a number of data lines 104′ that are used to generate the second signals for each row 107 may be based on a desired noise performance. For example, the spacing of the data lines 104′ may be selected based on a signal to noise ratio that is greater than 8, 10, 16 or more. A number of data lines 104′ per row may be a percentage of the number of columns 109 such as 5, 10, or more.

The selection of the number of data lines 104′ may be based on the expected EMI. Magnetic fields may be spatially variant. The spacing of the data lines 104′ may be based on that spatial variance. The EMI that may pass through other EMI shielding may be relatively low frequency EMI. As a result, the placements of the data lines 104′ need not be adjacent to any given pixel 108a. The placement may be based on the expected magnitude and frequency of EMI.

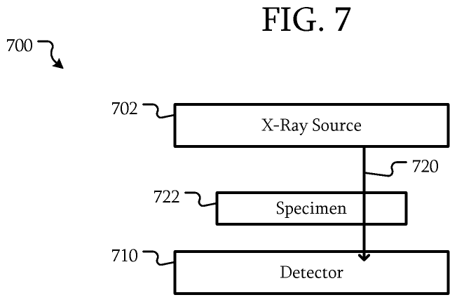

FIG. 7 is a block diagram of a 2D x-ray imaging system according to some embodiments. The 2D x-ray imaging system 700 includes an x-ray source 702 and detector 710. The detector 710 may be similar to a detector 100 including an array 102 or the like as described above. The x-ray source 702 is disposed relative to the detector 710 such that x-rays 720 may be generated to pass through a specimen 722 and detected by the detector 710. In some embodiments, the detector 710 is part of a medical imaging system, non-destructive testing system, or the like. In other embodiments, the 2D x-ray imaging system 700 may include a portable vehicle scanning system as part of a cargo scanning system.

Some embodiments include a detector, comprising: a plurality of first pixels 108, each first pixel 108 configured to convert radiation into an electrical signal; and a first set of a plurality of data lines 104/104′ coupled to the first pixels 108; control logic 120 configured to receive at least one second signal through at least one data line 104′ of a second set of the plurality of data lines 104/104′ other than the first set of the plurality of the data lines 104/104′ and combine the at least one second signal with the first signals to generate modified first signals, wherein the at least one data line 104′ of the second set is: not coupled to any pixels; or is coupled to a second pixel 108′ with electrical connections that are different from electrical connections of the first pixels 108 such that for the second pixel 108′: components of the second pixel 108′ are different from components of each of the first pixels 108; electrical connections between components of the components of the second pixel 108′ are different from electrical connections between the components of each of the first pixels 108; or a number of electrical connections to the second pixel 108′ are different from a number of electrical connections to each of the first pixels 108.

Some embodiments include a detector, comprising: a plurality of first pixels 108, each first pixel 108 configured to convert radiation into an electrical signal; a plurality of second pixels 108′; and a plurality of data lines 104/104′ coupled to the first pixels 108 and the second pixels 108′; control logic 120 configured to combine a signal from at least one of the second pixels 108′ with an electrical signal from one of the first pixels 108; wherein electrical connections of each of the second pixels 108′ are different from electrical connections of the first pixels 108 such that for each second pixel: components of the second pixel 108′ are different from components of each of the first pixels 108; electrical connections between components of the components of the second pixel 108′ are different from electrical connections between the components of each of the first pixels 108; or a number of electrical connections to the second pixel 108′ are different from a number of electrical connections to each of the first pixels 108.

In some embodiments, each first pixel 108 comprises: a sensor 110; and a switch 112 electrically connected between the sensor 110 and an associated one of the data lines 104/104′; and each second pixel 108′ comprises: a sensor 110; and a switch 112 electrically connected to an associated one of the data lines 104/104′ and electrically disconnected from the sensor 110.

In some embodiments, each first pixel 108 comprises: a sensor 110; and a switch 112 electrically connected between the sensor 110 and an associated one of the data lines 104; and each second pixel 108′ does not include a sensor 110.

In some embodiments, the detector further comprises a plurality of gate lines 106 associated with the first pixels 108 and the second pixels 108′; wherein for the electrical connections of each second pixel 108′ that are different from the first pixels 108, a transistor 112 of each of the first pixels 108 is electrically connected to a corresponding one of the gate lines 106 and a corresponding transistor 112 of each of the second pixels 108′ is not electrically connected to a corresponding one of the gate lines 106.

In some embodiments, the first pixels 108 and the second pixels 108′ are disposed in rows 107 and columns 109 of an array 102; and each row 107 of the array 102 includes at least one of the first pixels 108 and at least one of the second pixels 108′.

In some embodiments, at least one group of the second pixels 108′ form one of the columns 109 of the array 102.

In some embodiments, the second pixels 108′ are disposed in multiple groups; and each group of the second pixels 108′ forms a corresponding one of the columns 109 of the array 102.

In some embodiments, each column 109 of the array 102 includes at least one first pixel 108.

In some embodiments, each second pixel 108′ of a row 107 of the array 102 is offset along the row 107 of the array 102 from at least one second pixel 108′ in another row 107 of the array 102.

In some embodiments, the second pixels 108′ have a substantially uniform density across the array 102.

In some embodiments, the data lines 104/104′ comprise first data lines 104 and at least one second data line 104′; the first data lines 104 are coupled to the first pixels 108; the at least one second data line 104′ is coupled to the second pixels 108′ each of the at least one second data line 104′ is disposed in parallel with and along a corresponding one of the first data lines 104; and the control logic 120 is configured to adjust electrical signals from the first pixels 108 based on electrical signals received through at least one of the at least one second data line 104′.

In some embodiments, the control logic 120 is configured combine the electrical signal from one of the first pixels 108 with a signal based on interpolating signals from at least two of the second pixels 108′.

In some embodiments, the first pixels 108 and the second pixels 108′ are disposed in rows 107 and columns 109 of an array 102; each row 107 of the array 102 includes more than one of the first pixels 108 and more than one of the second pixels 108′; and for each first pixel 108 of a row, the control logic 120 is configured to combine the electrical signal from the first pixel 108 with a combination of electrical signals from at least two of the second pixels 108′ of the row 107.

In some embodiments, each second pixel 108′ has electrical connections to reduce the electrical signal due to radiation conversion relative to a neighboring first pixel 108 on one of the plurality of data lines 104/104′ coupled to the second pixel 108′.

In some embodiments, data lines 104′ coupled to the second pixels 108′ are not coupled to the first pixels 108.

In some embodiments, for each of the data lines 104′ coupled to the second pixels 108′, a number of second pixels 108′ coupled to that data line 104′ is less than a number of first pixels 108 coupled to an associated data line 104 that is coupled to first pixels 108.

Some embodiments include a detector, comprising: a plurality of pixels 108, each pixel 108 configured to convert radiation into an electrical signal; a plurality of data lines 104/104′ including a first set of data lines 104 coupled to the pixels 108 and a second set of data lines 104′ not coupled to the pixels 108; and control logic 120 configured to, for each of the pixels 108, combine an electrical signal from the data lines 104 of the first set coupled to the pixel 108 with an electrical signal from at least one data line 104′ from the second set of data lines 104′.

In some embodiments, the detector further comprises a switch 112 coupled to each of the data lines 104′ of the second set.

Some embodiments include a method, comprising: receiving a plurality of first signals from first pixels 108 configured to convert radiation into electrical signals through a first set of a plurality of data lines 104; receiving at least one second signal through at least one data line 104′ of a second set of the plurality of data lines 104/104′ other than the first set of the plurality of the data lines 104, wherein the at least one data line 104′ of the second set is: not coupled to any pixels; or is coupled to a second pixel 108′ with electrical connections that are different from electrical connections of the first pixels 108 such that for the second pixel: components of the second pixel 108′ are different from components of each of the first pixels 108; electrical connections between components of the components of the second pixel 108′ are different from electrical connections between the components of each of the first pixels 108; or a number of electrical connections to the second pixel 108′ are different from a number of electrical connections to each of the first pixels 108; and combining the at least one second signal with the first signals to generate modified first signals.

In some embodiments, for each row 107 of an array 102 including the first pixels 108, the at least one data line 104′ of the plurality of data lines 104/104′ other than the first set of the plurality of the data lines 104 are the same as other row 107.

In some embodiments, for at least one row 107 of an array 102 including the first pixels 108, the at least one data line 104′ of the plurality of data lines 104/104′ other than the first set of the plurality of data lines 104/104′ are different from another row 107.

In some embodiments, combining the at least one second signal with the first signals to generate the modified first signals comprises: interpolating multiple second signals of the at least one second signal to generate an interpolated second signal for each of the first signals; and combining each first signal with a corresponding interpolated second signal.

Some embodiments include a detector, comprising: means for receiving a plurality of first signals from first pixels configured to convert radiation into electrical signals through a first set of a plurality of data lines; means for receiving at least one second signal through at least one data line of a second set of the plurality of data lines other than the first set of the data lines, wherein the at least one data line of the second set is: not coupled to any pixels; or is coupled to a second pixel with electrical connections that are different from electrical connections of the first pixels such that for the second pixel: components of the second pixel are different from components of each of the first pixels; electrical connections between components of the components of the second pixel are different from electrical connections between the components of each of the first pixels; or a number of electrical connections to the second pixel are different from a number of electrical connections to each of the first pixels; and means for combining the at least one second signal with the first signals to generate modified first signals.

Examples of means for receiving a plurality of first signals from first pixels configured to convert radiation into electrical signals through a first set of a plurality of data lines include data lines 104, row drivers 122, control logic 120, or the like.

Examples of means for receiving at least one second signal through at least one data line of a second set of the plurality of data lines other than the first set of the data lines include data lines 104′, row drivers 122, control logic 120, or the like.

Examples of the means for combining the at least one second signal with the first signals to generate modified first signals include the control logic 120 or the like.

In some embodiments, the means for combining the at least one second signal with the first signals to generate the modified first signals comprises: means for interpolating multiple second signals of the at least one second signal to generate an interpolated second signal for each of the first signals; and means for combining each first signal with a corresponding interpolated second signal.

Examples of the means for interpolating multiple second signals of the at least one second signal to generate an interpolated second signal for each of the first signals include the control logic 120 or the like.

Examples of the means for combining each first signal with a corresponding interpolated second signal include the control logic 120 or the like.

Although the structures, devices, methods, and systems have been described in accordance with particular embodiments, one of ordinary skill in the art will readily recognize that many variations to the particular embodiments are possible, and any variations should therefore be considered to be within the spirit and scope disclosed herein. Accordingly, many modifications may be made by one of ordinary skill in the art without departing from the spirit and scope of the appended claims.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description. These additional embodiments are determined by replacing the dependency of a given dependent claim with the phrase “any of the claims beginning with claim [x] and ending with the claim that immediately precedes this one,” where the bracketed term “[x]” is replaced with the number of the most recently recited independent claim. For example, for the first claim set that begins with independent claim 1, claim 4 can depend from either of claims 1 and 3, with these separate dependencies yielding two distinct embodiments; claim 5 can depend from any one of claims 1, 3, or 4, with these separate dependencies yielding three distinct embodiments; claim 6 can depend from any one of claims 1, 3, 4, or 5, with these separate dependencies yielding four distinct embodiments; and so on.

Recitation in the claims of the term “first” with respect to a feature or element does not necessarily imply the existence of a second or additional such feature or element. Elements specifically recited in means-plus-function format, if any, are intended to be construed to cover the corresponding structure, material, or acts described herein and equivalents thereof in accordance with 35 U.S.C. § 112(f). Embodiments of the invention in which an exclusive property or privilege is claimed are defined as follows.

1. A detector, comprising:
a plurality of first pixels, each first pixel configured to convert radiation into an electrical signal;
a plurality of second pixels; and
a plurality of data lines coupled to the first pixels and the second pixels;
control logic configured to combine a signal from at least one of the second pixels with an electrical signal from one of the first pixels;
wherein electrical connections of each of the second pixels are different from electrical connections of the first pixels such that for each second pixel:
components of the second pixel are different from components of each of the first pixels;
electrical connections between components of the components of the second pixel are different from electrical connections between the components of each of the first pixels; or
a number of electrical connections to the second pixel are different from a number of electrical connections to each of the first pixels.

2. The detector of claim 1, wherein:
each first pixel comprises:
a sensor; and
a switch electrically connected between the sensor and an associated one of the data lines; and
each second pixel comprises:
a sensor; and
a switch electrically connected to an associated one of the data lines and electrically disconnected from the sensor.

3. The detector of claim 1, wherein:
each first pixel comprises:
a sensor; and
a switch electrically connected between the sensor and an associated one of the data lines; and
each second pixel does not include a sensor.

4. The detector of claim 1, further comprising:
a plurality of gate lines associated with the first pixels and the second pixels;
wherein for the electrical connections of each second pixel that are different from the first pixels, a transistor of each of the first pixels is electrically connected to a corresponding one of the gate lines and a corresponding transistor of each of the second pixels is not electrically connected to a corresponding one of the gate lines.

5. The detector of claim 1, wherein:
the first pixels and the second pixels are disposed in rows and columns of an array; and
each row of the array includes at least one of the first pixels and at least one of the second pixels.

6. The detector of claim 5, wherein:
at least one group of the second pixels form one of the columns of the array.

7. The detector of claim 5, wherein:
the second pixels are disposed in multiple groups; and
each group of the second pixels forms a corresponding one of the columns of the array.

8. The detector of claim 5, wherein:
each second pixel of a row of the array is offset along the row of the array from at least one second pixel in another row of the array.

9. The detector of claim 5, wherein:
the second pixels have a substantially uniform density across the array.

10. The detector of claim 1, wherein:
the data lines comprise first data lines and at least one second data line;
the first data lines are coupled to the first pixels;
the at least one second data line is coupled to the second pixels each of the at least one second data line is disposed in parallel with and along a corresponding one of the first data lines; and
the control logic is configured to adjust electrical signals from the first pixels based on electrical signals received through at least one of the at least one second data line.

11. The detector of claim 1, wherein:
the control logic is configured combine the electrical signal from one of the first pixels with a signal based on interpolating signals from at least two of the second pixels.

12. The detector of claim 1, wherein:
the first pixels and the second pixels are disposed in rows and columns of an array;
each row of the array includes more than one of the first pixels and more than one of the second pixels; and
for each first pixel of a row, the control logic is configured to combine the electrical signal from the first pixel with a combination of electrical signals from at least two of the second pixels of the row.

13. The detector of claim 1, wherein:
each second pixel has electrical connections to reduce the electrical signal due to radiation conversion relative to a neighboring first pixel on one of the plurality of data lines coupled to the second pixel.

14. The detector of claim 1, wherein:
data lines coupled to the second pixels are not coupled to the first pixels.

15. The detector of claim 14, wherein:
for each of the data lines coupled to the second pixels, a number of second pixels coupled to that data line is less than a number of first pixels coupled to an associated data line that is coupled to first pixels.

16. A method, comprising:
receiving a plurality of first signals from first pixels configured to convert radiation into electrical signals through a first set of a plurality of data lines;
receiving at least one second signal through at least one data line of a second set of the plurality of data lines other than the first set of the plurality of the data lines, wherein the at least one data line of the second set is:
not coupled to any pixels; or
is coupled to a second pixel with electrical connections that are different from electrical connections of the first pixels such that for the second pixel:
components of the second pixel are different from components of each of the first pixels;
electrical connections between components of the components of the second pixel are different from electrical connections between the components of each of the first pixels; or
a number of electrical connections to the second pixel are different from a number of electrical connections to each of the first pixels; and
combining the at least one second signal with the first signals to generate modified first signals.

17. The method of claim 16, wherein:
for at least one row of an array including the first pixels, the at least one data line of the plurality of data lines other than the first set of the plurality of data lines are different from another row.

18. The method of claim 16, wherein combining the at least one second signal with the first signals to generate the modified first signals comprises:
interpolating multiple second signals of the at least one second signal to generate an interpolated second signal for each of the first signals; and
combining each first signal with a corresponding interpolated second signal.

19. A detector, comprising:
means for receiving a plurality of first signals from first pixels configured to convert radiation into electrical signals through a first set of a plurality of data lines;
means for receiving at least one second signal through at least one data line of a second set of the plurality of data lines other than the first set of the data lines, wherein the at least one data line of the second set is:
not coupled to any pixels; or
is coupled to a second pixel with electrical connections that are different from electrical connections of the first pixels such that for the second pixel:
components of the second pixel are different from components of each of the first pixels;
electrical connections between components of the components of the second pixel are different from electrical connections between the components of each of the first pixels; or
a number of electrical connections to the second pixel are different from a number of electrical connections to each of the first pixels; and
means for combining the at least one second signal with the first signals to generate modified first signals.

20. The detector of claim 19, wherein the means for combining the at least one second signal with the first signals to generate the modified first signals comprises:
means for interpolating multiple second signals of the at least one second signal to generate an interpolated second signal for each of the first signals; and
means for combining each first signal with a corresponding interpolated second signal.
